(19) United States
(12) Patent Application Publication
(10) Pub. No.: US 2014/0160287 A1
(43) Pub. Date: Jun. 12, 2014

(54) GUIDE METHOD OF A REVERSE GUIDELINE SYSTEM

(71) Applicant: E-LEAD ELECTRONIC CO., LTD., Changhua (TW)

(72) Inventor: Stephen CHEN, CHANGHUA (TW)

(73) Assignee: E-LEAD ELECTRONIC CO., LTD., Changhua (TW)

(21) Appl. No.: 13/708,418

(22) Filed: Dec. 7, 2012

(51) Int. Cl. G08G 1/0962

(52) U.S. Cl. CPC G08G 1/0962
USPC 348/148

(57) ABSTRACT

A guide method of a reverse guideline system, wherein a reverse guideline system is used to draw a reverse guideline on the image shot behind the car, the reverse guideline system comprises a detected and computed reverse direction route line and an actual direction curve, which is computed according to the current steering wheel angle, each route line of the reverse direction route line, which is marked by different features to increase the recognition, is served as the basis for the driver operating the steering wheel, the driver reverses the car according to the planed parking path as long as the front sections of the actual direction curve and the reverse direction route line are overlapped, to thereby guide the driver to park in the parking space quickly.

### BACKGROUND OF THE INVENTION

1. Field of the Invention

A guide method of a reverse guideline system, wherein a reverse guideline system is used to draw a reverse guideline on the rear image, the driver may park the car quickly in the parking space through the guide of an actual direction curve and a reverse direction route line with different marked features.

2. Brief Description of the Related Art

Reversing the car is the most difficult action when driving the car, especially reversing the car is a particular parking space. Since the logic of the rotation action of the steering wheel is different when reversing and going forward, and also the driver cannot see the back of the car, the reverse rear view camera is created for the driver to see the reverse rear view through the display. However, due to the wide-angle lens, the rear image is distorted, also affected by the mirror effect, most people cannot correctly determine the actual distance from the image easily. Therefore, the design of adding the alignment lines of the parking space in the camera image is developed for marking as the alignment of the parking space. Here, the alignment lines of the parking space is based on the straight reversing, but actually, it is difficult for the driver to reverse the car straight exactly while reversing and parking, thus the effect of the alignment lines of the parking space is limited. Hence a dynamic reverse route line whose radian may be changed with the rotation of the steering wheel is developed, and the driver could know the reverse route line corresponded to the current steering wheel angle in advance. The control of the steering wheel is random and modulated continuously while reversing and the dynamic reverse route line changes continuously, many drivers may be confused and not have enough time to react. The above reverse assistance devices and methods may have some effect, especially when parking the car in a particular location on the road, but the utility is quite limited. Generally, the most difficult thing when reversing is to reverse the car in a particular parking space, and the reverse parking method nothing else but vertical parking, that is to say, reversing the car with rotating 90 degree and parking in a parking space or a garage on the rear side vertical to the car (namely, reversing the car into a garage); another one is parallel parking, that is to say, reversing the car in a parking space or location on the rear side parallel to the car (namely, street parking).

In order to solve the above problems, the industries proposed various patent cases, the typical cases as follow:

1. The cited reference 1 is the patent case TW 1335281, which is a parking guide system and its guide method. By the composition of a display, an image sensor, a car speed sensor and an electric control device, the image captured by the image sensor is send to the electric control device for judging a predetermined parking location, the relative coordinates of the current location and the predetermined parking location is obtained from the captured image and the car speed, to thereby estimate a start location for parking and draw a specific going-forward guide track between the current location of the car and the predetermined parking location via the start location for parking, or a going-forward guide track from the current location to start location for parking on the display according to the parking mode. The driver may park the car easily and quickly by referring to the display and also may avoid collision occurring. A specific going-forward or reversing guide track is connected by lines from the start location for parking, and between the start location for parking and the predetermined parking location, the guide track is displayed on the display. At the same time, a car steering track is estimated according to a car offset angle obtained by a steering sensor and displayed on the display. The driver may control the steering wheel to make the car steering track going along the guide track to complete the parking operation. In the cited reference 1, the planed route is calculated first and then drawn on the reverse image for overlapping with the actual image, and the reverse guideline may be changed while turning the steering wheel. While reversing, the driver has only to operate the steering wheel to overlap the reverse guideline and the planed route, and the car may be reversed in the parking location correctly. But, in the cited reference 1, since the parking route is complicated and lack obvious distinctions in the screen, the driver may easily mistake in visual in a short time, and a difference from the actual location may be created to affect the reverse operation and proceeding.

2. The cited reference 2 is the patent case TW M424272, which is a parking guide system with displaying the surrounding image of the car. When the car near a parking space, a start setting module is pressed to start the system, the system then generates set operating signals, to let a camera module setting around the car shooting the surroundings of the car to generate image signals. And a judgment module receives the set operating signals and the image signals, judges the location of the car according to car speed, gear, rotation angle of the steering wheel of the car, and generates a judgment result. A display module displays a surrounded image of the car, a parking setting standard line, an operation icon, a parking guide track line and a dynamic track line according to the judgment result, to guide the driver for parking the car, to thereby achieve the purpose of parking assistance and parking auxiliary. When the dynamic track line displayed on the display module is not overlapped with the parking guide track line, it means that the dynamic track line and the parking guide track line have some distance from each other. Thus, when the driver sees the abovementioned image displayed on the display module, it means that the driving route corresponding to the rotation angle of the steering wheel is different from the recommended driving route generated by the judgment module. The driver should adjust the rotation angle of the steering wheel, let the dynamic track line varies with the parking guide track line for overlapping the dynamic track line and the parking guide track line. In the cited reference 2, the planed route is calculated first, and then drawn on the reverse rear image for overlapping with the actual view, and the reverse guideline may be changed while turning the steering wheel. While reversing, the driver has only to operate the steering wheel to overlap the reverse guideline and the planed route, and the car may be reversed in the parking location correctly. But the cited reference 2 also has the problem that the parking route is lack obvious distinctions, the parking route is complicated in the screen, the driver may easily mistake in visual in a short time to affect the reverse operation and proceeding.

Except for the cited references 1, 2, there are also a plenty of related patent cases, but only few of them may help drivers parking quickly. The reason is that the planed routes may not be displayed in the rear image timely, or the parking route is complicated and lack obvious distinctions in the screen, drivers may not know the correct guide route in a short time, once when the car is slightly moved, the guide route is corrected slowly and has difference from the actual location.

### SUMMARY OF THE INVENTION

In view of this, in the guide method of a reverse guideline system of the present invention, a reverse guideline system is used to calculate a route from the current location of the car to the predetermined target parking space through the way of setting or detection, the route is directly drawn in the rear image for guiding the driver to operate the car parking in the predetermined target parking space according to the planned route, to thereby provide an essential and effective reverse aid to the driver; namely, the purpose of the present invention is to provide a guide method of a reverse guideline system with high identification, to guide the driver to park the car in the parking space quickly, to thereby solve the drawbacks of the conventional ones.

To achieve the object, in the present invention, a reverse guideline system is used to guide a driver for reversing a car, the reverse guideline system includes a rear camera unit, a display unit, a motion detection unit, a steering-wheel-angle detection unit, a relative position calculating unit and a central processing unit, under the operation of the reversing guideline system, the guide method of the reverse guideline system of the present invention comprises at least the following steps:

(1) the relative position calculating unit calculates the relative position of a parking target area and the car, the central processing unit calculates a reverse direction route line according to the relative position of the parking target area and the specification of the car;

(2) the reverse direction route line is connected by multiple route lines with different fixed steering-wheel angles, each route line of the reverse direction route line is marked with different features and overlapped on the rear image of the car shot by the rear camera unit to thereby display the reverse direction route line from the car to the parking target area on the rear image;

(3) an actual direction curve of the car is drawn in the rear image according to the steering wheel angle detected by the steering-wheel-angle detection unit, the actual direction curve is changed to overlap on the route line of the reverse direction route line by turning the steering wheel of the car, and the car is moved along the planned reverse direction route line;

(4) the motion detection unit calculates the moving route line of the car, the route line of the reverse direction route line is shortened gradually, when reaching a route line with different fixed steering-wheel angel, turning the steering wheel of the car to change the actual direction curve for overlapping the route line of the reverse direction route line again, the car is parked in the parking target area until the reverse direction route line is completely disappeared.

The reverse direction route line of the present invention is connected by multiple route lines with different fixed steering-wheel angles, the steering fixed steering-wheel angles include an angle with the steering wheel turned right to the end, an angle with the steering wheel turned left to the end, and an angle with the steering wheel centered.

The actual direction curve of the present invention is the reverse rotation curve consisted according to the current steering wheel angle of the car.

The actual direction curve of the present invention is the nearest curve, which is consisted of the reverse rotation curve consisted according to the current steering wheel angle of the car, is connected to the follow-up route lines similar to the reverse direction route line according to the steering wheel angle of the curve.

Each route line of the reverse direction route line of the present invention is marked as different features, the features means color, lines, thickness, solid and dashed line styles.

The steering-wheel-angle detection unit of the present invention is used to receive the steering wheel angle provided from the steering-wheel signals.

The steering-wheel-angle detection unit of the present invention obtains the steering wheel angle from adding the rotation angle of the car detected by a gyroscope and the car speed.

The motion detection unit of the present invention is a car speed detection unit, which is used to calculate the moving amount with the time variation.

The motion detection unit of the present invention is a gyroscope, which is used to calculate the rotation angle of the car to thereby calculate the moving amount.

The relative position calculating unit of the present invention is an image recognition software, which calculates the moving amount by using the rear image of the rear camera unit.

The relative position calculating unit of the present invention is an image recognition software, which calculates the relative position of the parking target area and the car by using the rear image of the rear camera unit.

### BRIEF DESCRIPTION OF THE INVENTION

The detail structure, the applied principle, the function and the effectiveness of the present invention can be more fully understood with reference to the following description and accompanying drawings, in which:

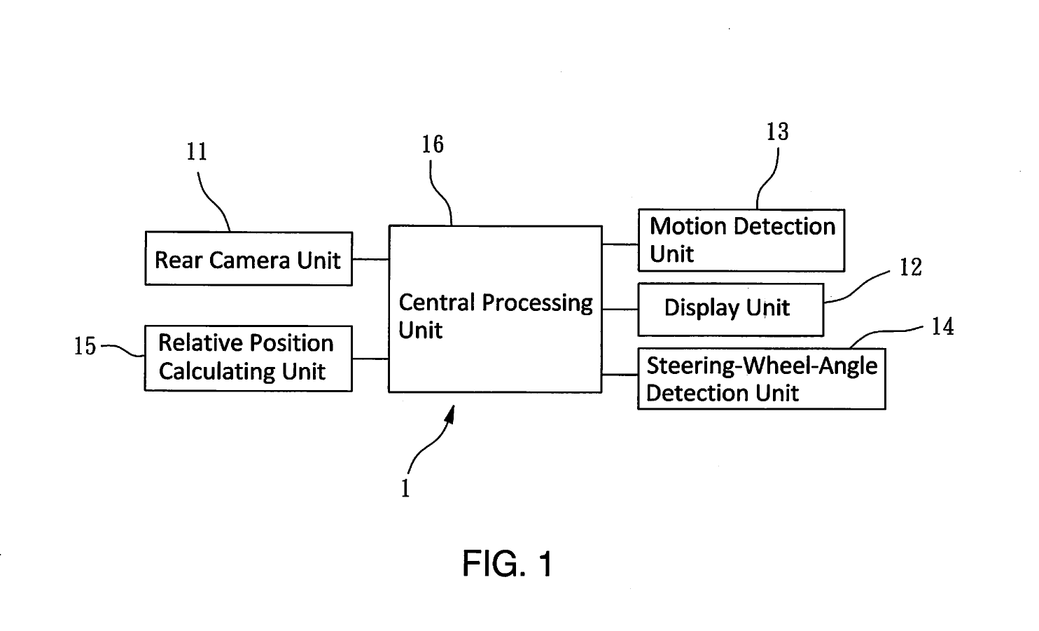

FIG. 1 is a block diagram of the system according to the present invention;

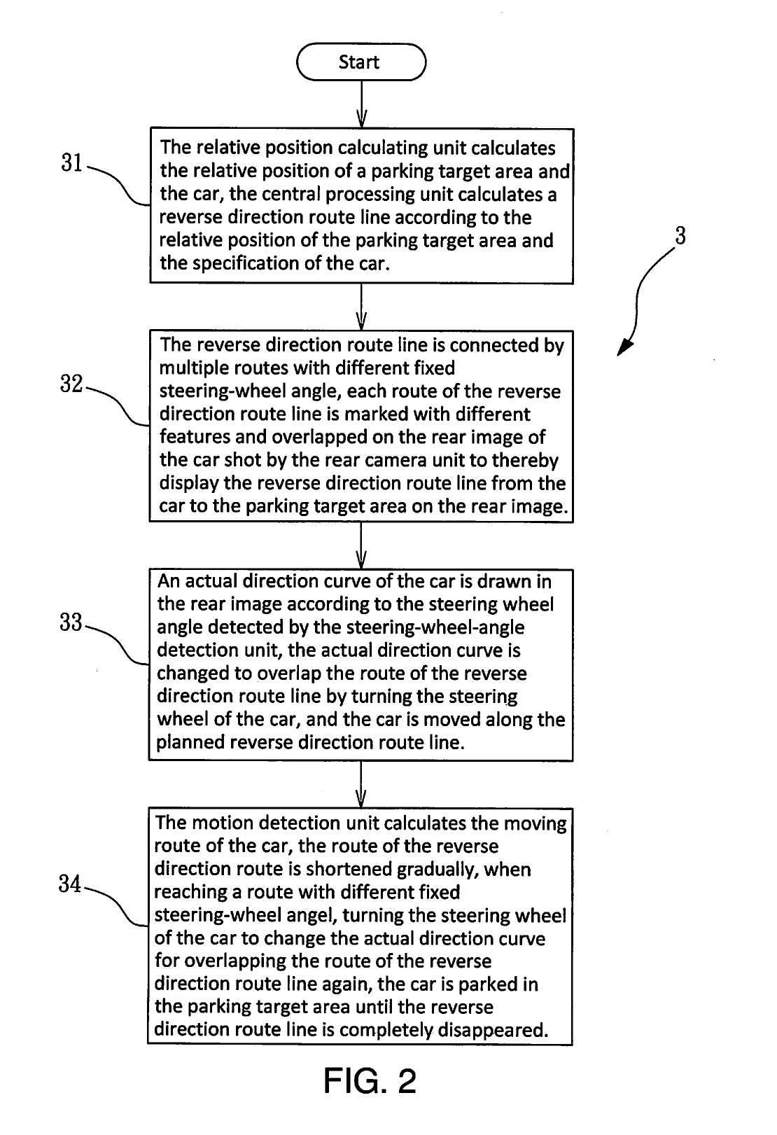

FIG. 2 is a flow chart of the guide method according to the present invention;

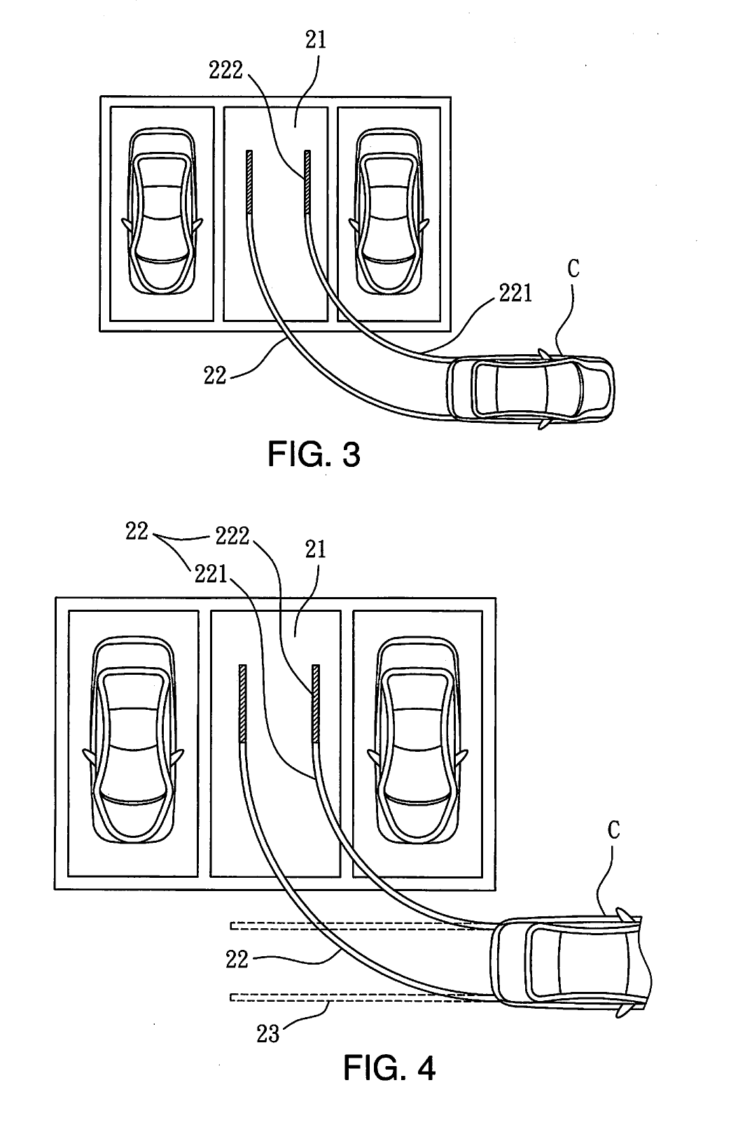

FIG. 3 is an operation diagram (1) of the first embodiment according to the present invention;

FIG. 4 is an operation diagram (2) of the first embodiment according to the present invention;

FIG. 5 is an operation diagram (3) of the first embodiment according to the present invention;

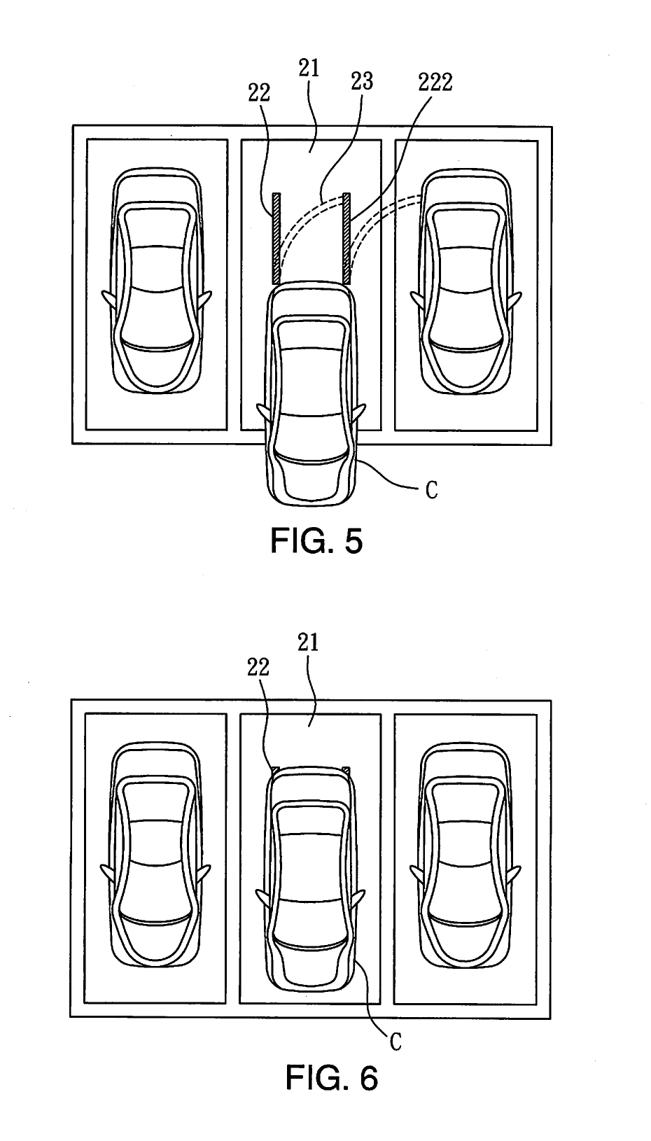

FIG. 6 is an operation diagram (4) of the first embodiment according to the present invention;

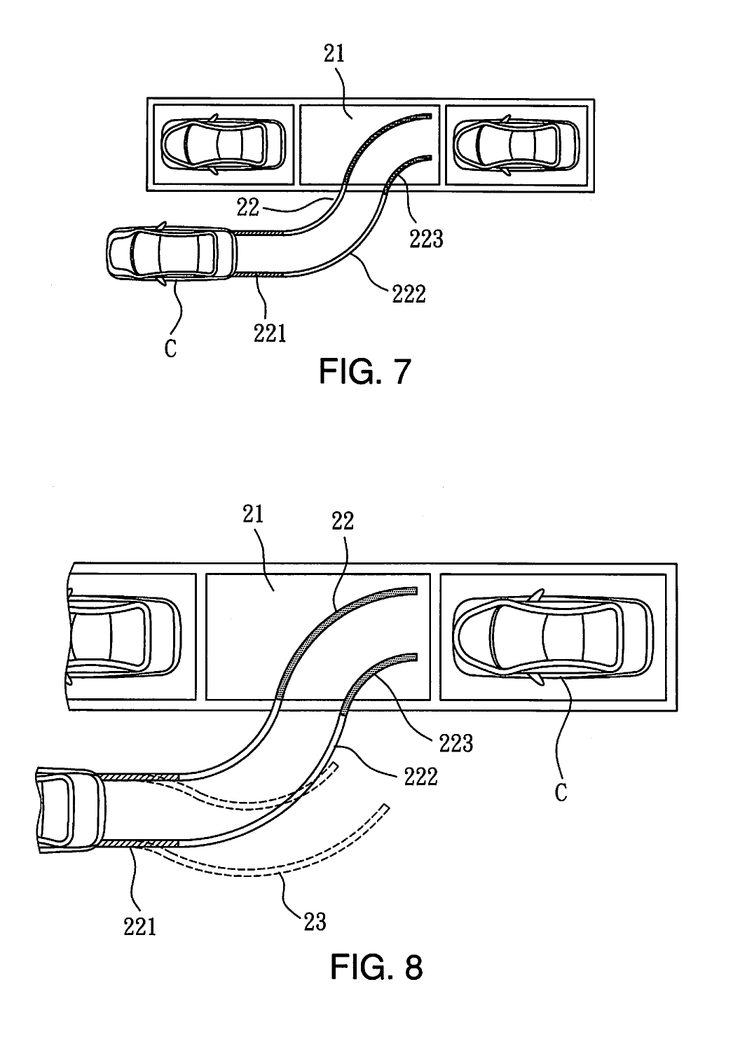

FIG. 7 is an operation diagram (1) of the second embodiment according to the present invention;

FIG. 8 is an operation diagram (2) of the second embodiment according to the present invention;

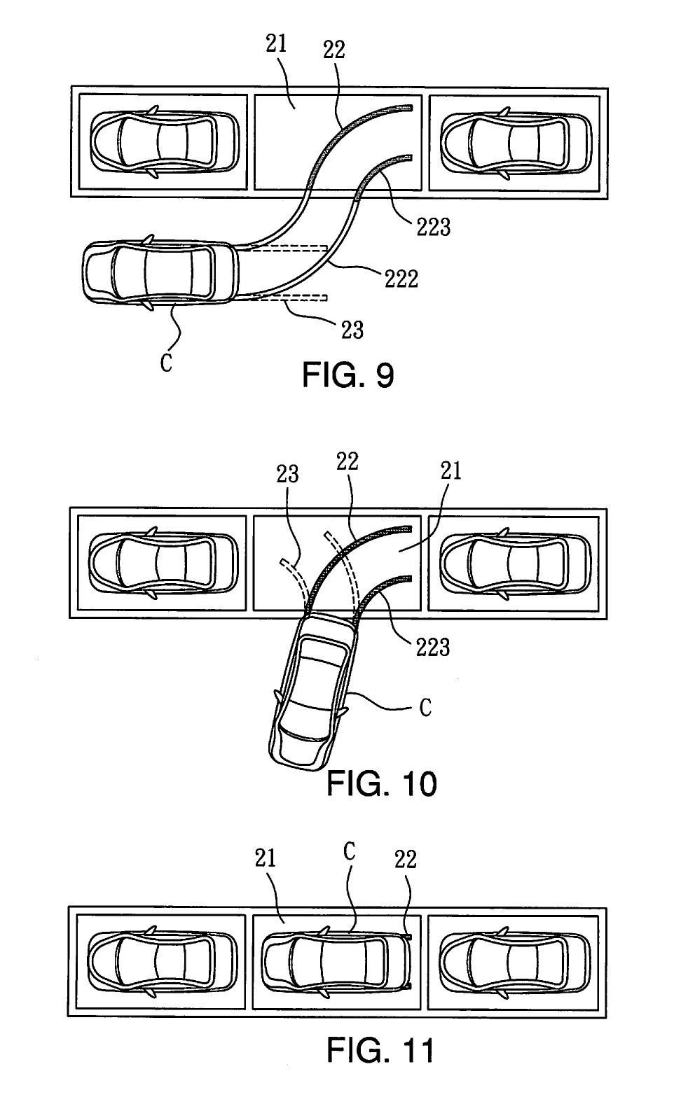

FIG. 9 is an operation diagram (3) of the second embodiment according to the present invention;

FIG. 10 is an operation diagram (4) of the second embodiment according to the present invention;

FIG. 11 is an operation diagram (5) of the second embodiment according to the present invention; and

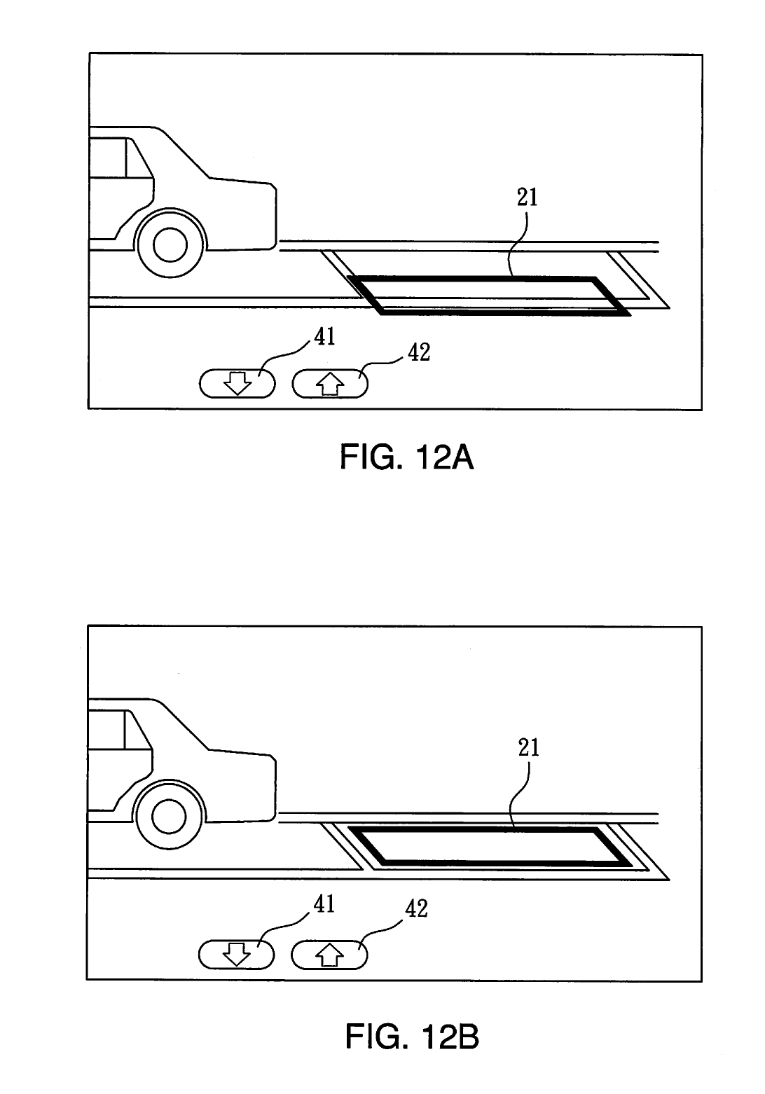

FIGS. 12A, 12B are operation diagrams of marking the parking area by the relative position calculating unit according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

As FIG. 1, FIG. 2, FIG. 3, FIG. 4, in the guide method 3 of the reverse guideline system of the present invention, the operation of a reverse guideline system 1 is used to guide a driver for reversing a car, the reverse guideline system 1 includes a rear camera unit 11, a display unit 12, a motion detection unit 13, a steering-wheel-angle detection unit 14, a relative position calculating unit 15 and a central processing unit 16, wherein:

the rear camera unit 11, which is connected to the central processing unit 16, is installed in the rear of the car C (which means the car driven by the driver) to shoot the rear image of the car C;

the display unit 12, which is connected to the central processing unit 16, is provided to display an reverse direction route line 22, the position of the car C, the image shot by the rear camera unit 11, and the image of an actual direction curve 23, the above display image includes a combined image, which is computed and graphic-processed by the central processing unit 16;

the motion detection unit 13, which is used to detect a car motion signal for the central processing unit 16 to calculate a moving amount;

the steering-wheel-angle detection unit 14, which is used to detect a steering-wheel-angle signal for the central processing unit 16 to calculate a steering wheel angle;

the relative position calculating unit 15, which is connected to the central processing unit 16, is provided to the relative position of the parking target area 21 and the car;

the central processing unit 16, which is connected to the rear camera unit 11, the display unit 12, the motion detection unit 13, the steering-wheel-angle detection unit 14 and the relative position calculating unit 15 and is provided to receive information and signals from the above units for computation and graphic-processing, and the central processing unit 16 has a basic data of the car C (the basic data includes the minimum radius of rotation of the car C and the car size, such as wheelbase, the length from the front wheel to the front edge of the corner, the length from the rear wheel to the rear edge of the corner) and a route line computation software for computing best reverse path, to plan a reverse direction route line 22 with turning the steering wheel to the end, calculate the reverse traveling location according to the motion detection unit 13 and the steering-wheel-angle detection unit 14, perform computation and graphic-processing on the reverse direction route line 22 and the actual direction curve 23 by the central processing unit 16, to thereby display a combined image in the display unit 12.

The guide method 3 of the reverse guideline system of the present invention is provided to guide the driver to reverse the car under the action of the reverse guideline system 1, the guide method 3 of the reverse guideline system 1 of the present invention has two kind of embodiments, wherein the first embodiment is the method of reversing the car into a garage, the guide method 3 at least includes the following steps (as FIG. 2):

(1) the relative position calculating unit calculates the distance to a parking target area from the car, the central processing unit calculates a reverse direction route line according to the relative position of the parking target area and the specification of the car (step 31);

(The execution of step 31 is illustrated as FIG. 1 and FIG. 3, the display unit 12 displays the rear image shot by the rear camera unit 11, the relative position calculating unit 15 calculates the relative position of a parking target area 21 and the car, the central processing unit 16 calculates a reverse direction route line 22 according to the relative position of the parking target area 21 and the specification of the car C.)

(2) the reverse direction route line is connected by multiple route lines with different fixed steering-wheel angles, each route line of the reverse direction route line is marked with different features and overlapped on the rear image of the car shot by the rear camera unit to thereby display the reverse direction route line from the car to the parking target area on the rear image (step 32);

(In step 32, the reverse direction route line 22 is connected by multiple route lines with different fixed steering-wheel angles, each route line 221, 222 of the reverse direction route line 22 is marked with different features, the reverse direction route line 22 is displayed on the display unit 12 and overlapped on the rear image of the car shot by the rear camera unit 11, the reverse direction route line 22 from the car to the parking target area 21 is displayed on the rear image.)

(3) an actual direction curve of the car is drawn in the rear image according to the steering wheel angle detected by the steering-wheel-angle detection unit, the actual direction curve is changed to overlap on the route line of the reverse direction route line by turning the steering wheel of the car, and the car is moved along the planned reverse direction route line (step 33);

(The execution of step 33 is illustrated as FIG. 4, the actual direction curve 23 of the car is drawn in the rear image according to the steering wheel angle detected by the steering-wheel-angle detection unit 14, the actual direction curve 23 is changed to overlap on the route line 221 of the reverse direction route line 22 by turning the steering wheel of the car, at this time, reversing the car with the fixed steering wheel angle, and the car C is moved along the planned reverse direction route line 22.)

(4) the motion detection unit calculates the moving route line of the car, the route line of the reverse direction route line is shortened gradually, when reaching a route line with different fixed steering-wheel angel, turning the steering wheel of the car to change the actual direction curve for overlapping the route line of the reverse direction route line again, the car is parked in the parking target area until the reverse direction route line is completely disappeared (step 34).

(The execution of step 34 is illustrated as FIG. 5, the motion detection unit 13 calculates the moving route line of the car, the route line of the reverse direction route line 22 is gradually shortened with the current actual position of the car C until the route line 221 is completely disappeared, a route line with different fixed steering-wheel angel is reached when the route line 221 is completely disappeared, the steering wheel has not been turned yet at this time, so the actual direction curve 23 and the reverse direction route line 22 are completely different, turning the steering wheel of the car C and then the actual direction curve 23 is changed according to the steering wheel angle detected by the steering-wheel-angle detection unit 14, to thereby overlap the actual direction curve 23 and the route line 222 of the reverse direction route line 22, at this time, the car C continues moving along the planned reverse direction route line 22; and then, as shown in FIG. 6, while the reversed car is gradually approaching the parking target area 21, the reverse direction route line 22 is gradually shortened with the current actual position of the car C, the car C is parked in the parking target area 21 until the reverse direction route line 22 is completely disappeared.)

And, the guide method 3 of the reverse guideline system according to the present invention, wherein the second embodiment is parallel parking mode (namely, on-street parking mode), the guide method 3 at least comprises the following steps (as FIG. 2):

(1) the relative position calculating unit calculates the relative position to a parking target area from the car, the central processing unit calculates a reverse direction route line according to the relative position of the parking target area and the specification of the car (step 31);

(The execution of step 31 is illustrated as FIG. 1 and FIG. 7, the display unit 12 displays the rear image shot by the rear camera unit 11, the relative position calculating unit 15 calculates the relative position of a parking target area 21 and the car C, the central processing unit 16 calculates a reverse direction route line 22 according to the relative position of the parking target area 21 and the specification of the car C.)

(2) the reverse direction route line is connected by multiple route lines with different fixed steering-wheel angles, each route line of the reverse direction route line is marked with different features and overlapped on the rear image of the car shot by the rear camera unit, to thereby display the reverse direction route line from the position of the car to the parking target area on the rear image (step 32);

(In step 32, the reverse direction route line 22 is connected by multiple route lines with different fixed steering-wheel angles, each route line 221, 222, 223 of the reverse direction route line 22 is marked with different features, the reverse direction route line 22 is displayed on the display unit 12 and overlapped on the rear image of the car shot by the rear camera unit 11, the reverse direction route line 22 from the position of the car to the parking target area 21 is displayed on the rear image.)

(3) the actual direction curve of the car is drawn in the rear image according to the steering wheel angle detected by the steering-wheel-angle detection unit, the actual direction curve is changed to overlap on the route line of the reverse direction route line by turning the steering wheel of the car, and the car is moved along the planned reverse direction route line (step 33);

(The execution of step 33 is illustrated as FIG. 8, the actual direction curve 23 of the car C is drawn in the rear image according to the steering wheel angle detected by the steering-wheel-angle detection unit 14, the actual direction curve 23 is changed to overlap on the route line 221 of the reverse direction route line 22 by turning the steering wheel of the car, at this time, reversing the car with the fixed steering wheel angle, and the car C is moved along the planned reverse direction route line 22.)

(4) the motion detection unit calculates the moving route line of the car, the route line of the reverse direction route line is shortened gradually, when reaching a route line with different fixed steering-wheel angel, turning the steering wheel of the car to overlap the actual direction curve and the route line of the reverse direction route line again, the car is parked in the parking target area until the reverse direction route line is completely disappeared (step 34).

(The execution of step 34 is illustrated as FIG. 9, the motion detection unit 13 calculates the moving route line of the car, the reverse direction route line 22 is gradually shortened with the current actual position of the car C until the route line 221 is completely disappeared, a route line with different fixed steering-wheel angel is reached when the route line 221 is completely disappeared, the steering wheel has not been turned yet at this time, so the actual direction curve 23 and the route line 222 of the reverse direction route line 22 are completely different, when turning the steering wheel of the car C, the reverse direction route line 22 is changed to based on the steering wheel angle detected by the steering-wheel-angle detection unit 14, the actual direction curve 23 is displayed to overlap on the route line 222 of the reverse direction route line 22, at this time, the car C continues moving along the planned reverse direction route line 22; and then, as shown in FIG. 10, when the route line 222 is completely disappeared, a route line with a different fixed steering-wheel angles is reached, at this time, the steering-wheel has not been turned, so the actual direction curve 23 and the route line 223 of the reverse direction route line 22 are completely different, turning the steering wheel of the car C, the actual direction curve 23 is changed according to the steering wheel angle detected by the steering-wheel-angle detection unit 14, to thereby overlap the actual direction curve 23 and the route line 223 of the reverse direction route line 22, at this time, the car C continues moving along the planed reverse direction route line 22; finally, as shown in FIG. 11, while the reversed car C is gradually approaching the parking target area 21, the reverse direction route line 22 is gradually shortened with the current actual position of the car C, the car C is parked in the parking target area 21 until the reverse direction route line 22 is completely disappeared.)

Each route line of the reverse direction route line 22 of the present invention is marked as different features, the features means color, lines, thickness, solid and dashed line styles.

The reverse direction route line 22 of the present invention is connected by multiple route lines with different fixed steering-wheel angles, the steering fixed steering-wheel angles include an angle with the steering wheel turned right to the end, an angle with the steering wheel turned left to the end, and an angle with the steering wheel centered.

The actual direction curve 23 of the present invention is the reverse rotation curve consisted according to the current steering wheel angle of the car C.

The actual direction curve 23 of the present invention is the nearest curve, which is consisted of the reverse rotation curve consisted according to the current steering wheel angle of the car C, is connected to the follow-up route lines similar to the reverse direction route line 22 according to the steering wheel angle of the curve.

The motion signal of the car C detected by the motion detection unit 13 of the present invention is provided to the central processing unit 16 for calculating the moving amount of the car according to the motion signal, the calculating method is:

1. The method of calculating the moving amount of the car by the car speed detection unit, the calculation formula is D=V×T (D is the moving amount; V is speed, which means the car speed; T is time, which means the passing time of the car speed V), the moving amount (D) is obtained from the cumulative value of the car speed (V) and time (T).

2. The method of calculating the moving amount of the car by a gyroscope, calculating the rotation angle (θ) of the front of the car according to the gyroscope and then calculating the moving amount (D), the calculation formula is D=θ×radius, (D is the moving amount; θ is the rotation angle, radius means the minimum rotation radius of the car C).

3. The method of calculating the moving amount of the car by using the image recognition software, the moving amount (D) is calculated by calculating the image change of the rear image shot by the rear camera unit 11.

The resource of the steering-wheel-angle signals detected by the steering-wheel-angle detection unit 14 of the present invention is:

1. The steering-wheel-angle signals receive the steering wheel angle provided from the steering wheel itself.

2. The steering wheel angle is obtained from adding the rotation angle of the car detected by a gyroscope and the car speed.

3. The steering wheel angle is obtained from the gyroscope operated in coordination with the acceleration sensor.

The steering-wheel-angle detection unit 14 of the present invention is provided to detect whether or not the driver turns the steering wheel to the angle with the steering wheel centered, the angle with the steering wheel turned left to the end or the angle with the steering wheel turned right to the end according to the guide, and remove the reverse parking guide when detecting that the driver does not turn the steering-wheel or control the traveling direction of the car according to the guide.

The relative position calculating unit 15 of the present invention (as FIG. 12) is the manual mode that users may move the marks to the parking area in the actual scene on the screen, the parking target area 21 can be moved on the display unit 12, an up arrow key 41 and a down arrow key 42 displayed on the display unit 12 are provided for adjusting control, the up arrow key 41 and the down arrow key 42 are provided for adjusting the location of the parking target area 21, and the relative location of the car and the parking target area 21 is calculated according to the coordinate change of the moved marks.

The relative position calculating unit 15 is an image recognition software, which calculates the relative position of the parking target area 21 and the car C by using the rear image of the rear camera unit 11, the relative position calculating unit 15 further includes an obstacle detector, which is operated in coordination with the image recognition software to detect a parking space when the car passing through a parking area, and deduce the relative position of the parking target area 21 and the car C based on the moving amount to the starting point of the parking path.

I claim:

1. A guide method of a reverse guideline system, wherein the operation of a reverse guideline system is used to guide a driver for reversing a car, the reverse guideline system includes a rear camera unit, a display unit, a motion detection unit, a steering-wheel-angle detection unit, a relative position calculating unit, a central processing unit, the guide method at least comprises the following steps:
(1) the relative position calculating unit calculates the relative position of a parking target area and the car, the central processing unit calculates a reverse direction route line according to the relative position of the parking target area and the specification of the car;
(2) the reverse direction route line is connected by multiple route lines with different fixed steering-wheel angles, each route line of the reverse direction route line is marked with different features and overlapped on the rear image of the car shot by the rear camera unit to thereby display the reverse direction route line from the car to the parking target area on the rear image;
(3) an actual direction curve of the car is drawn in the rear image according to the steering wheel angle detected by the steering-wheel-angle detection unit, the actual direction curve is changed to overlap on the route line of the reverse direction route line by turning the steering wheel of the car, and the car is moved along the planned reverse direction route line;
(4) the motion detection unit calculates the moving route line of the car, the route line of the reverse direction route line is shortened gradually, when reaching a route line with different fixed steering-wheel angel, turning the steering wheel of the car to change the actual direction curve for overlapping the route line of the reverse direction route line again, the car is parked in the parking target area until the reverse direction route line is completely disappeared.

2. The guide method of a reverse guideline system as claimed in claim 1, wherein the reverse direction route line is connected by multiple route lines with different fixed steering-wheel angles, the steering fixed steering-wheel angles include an angle with the steering wheel turned right to the end, an angle with the steering wheel turned left to the end, and an angle with the steering wheel centered.

3. The guide method of a reverse guideline system as claimed in claim 1, wherein the actual direction curve is the reverse rotation curve consisted according to the current steering wheel angle of the car.

4. The guide method of a reverse guideline system as claimed in claim 1, wherein the actual direction curve is the nearest curve, which is consisted of the reverse rotation curve consisted according to the current steering wheel angle of the car, is connected to the follow-up route lines similar to the reverse direction route line according to the steering wheel angle of the curve.

5. The guide method of a reverse guideline system as claimed in claim 1, wherein each route line of the reverse direction route line is marked as different features, the features means color, lines, thickness, solid and dashed line styles.

6. The guide method of a reverse guideline system as claimed in claim 1, wherein the steering-wheel-angle detection unit is used to receive the steering wheel angle provided from the steering-wheel signals.

7. The guide method of a reverse guideline system as claimed in claim 1, wherein the steering-wheel-angle detection unit obtains the steering wheel angle from adding the rotation angle of the car detected by a gyroscope and the car speed.

8. The guide method of a reverse guideline system as claimed in claim 1, wherein the motion detection unit is a car speed detection unit, which is used to calculate the moving amount with the time variation.

9. The guide method of a reverse guideline system as claimed in claim 1, wherein the motion detection unit is a gyroscope, which is used to calculate the rotation angle of the car to thereby calculate the moving amount.

10. The guide method of a reverse guideline system as claimed in claim 1, wherein the relative position calculating unit is an image recognition software, which calculates the image change by using the rear image of the rear camera unit to thereby calculate the moving amount.

11. The guide method of a reverse guideline system as claimed in claim 1, wherein the relative position calculating unit is an image recognition software, which calculates the relative position of the parking target area and the car by using the rear image of the rear camera unit.
